(19) United States
(12) Patent Application Publication
(10) Pub. No.: US 2026/0195591 A1
(43) Pub. Date: Jul. 9, 2026

(54) TOKEN PRUNING BY TEMPORAL PROPAGATION OF ATTENTION ROLLOUT

(71) Applicant: SAMSUNG ELECTRONICS CO., LTD., Suwon-si (KR)

(72) Inventors: Niv ZEHNGUT, Tel-Aviv (IL); Yonatan DINAI, Tel-Aviv (IL); Ishay GOLDIN, Tel-Aviv (IL); Avraham RAVIV, Tel-Aviv (IL)

(73) Assignee: SAMSUNG ELECTRONICS CO., LTD., Suwon-si (KR)

(21) Appl. No.: 19/442,651

(22) Filed: Jan. 7, 2026

Related U.S. Application Data
(60) Provisional application No. 63/743,021, filed on Jan. 8, 2025.

(51) Int. Cl. G06N 3/082; G06N 3/045

(52) U.S. Cl. CPC G06N 3/082; G06N 3/045

(57) ABSTRACT

An electronic device for processing sequential input data, including: at least one processor; and memory configured to store a transformer-based neural network model, and instructions which, when executed by the at least one processor, cause the electronic device to: obtain sequential input data comprising a first data instance corresponding to a first time point, and a second data instance corresponding to a second time point subsequent to the first time point; provide a plurality of first input tokens corresponding to the first data instance to at least one attention block included in the transformer-based neural network model to obtain a plurality of first output tokens; generate a plurality of first output importance scores corresponding to the plurality of first output tokens; generate a plurality of first input importance scores corresponding to the plurality of first input tokens based on the plurality of first output importance scores; propagate the plurality of first input importance scores from the first data instance to the second data instance to generate a plurality of second input importance scores corresponding to the second data instance; prune a plurality of second input tokens corresponding to the second data instance based on the plurality of second input importance scores to obtain a pruned plurality of second input tokens; and provide the pruned plurality of second input tokens to the at least one attention block to obtain a plurality of second output tokens.

### CROSS-REFERENCE TO RELATED APPLICATION

This application is based on and claims priority under 35 U.S.C. § 119 to U.S. Provisional Application No. 63/743,021, filed on Jan. 8, 2025, in the United States Patent and Trademark Office, the disclosure of which is incorporated by reference herein in its entirety.

### BACKGROUND

### 1. Field

The present disclosure relates to artificial intelligence and neural network processing, and more particularly to systems, methods, and devices for pruning tokens which are used as input for a transformer-based neural network model to process sequential data.

### 2. Description of Related Art

A transformer-based neural network may refer to a type of neural network that may be trained to perform various tasks, such as detection tasks, recognition tasks, segmentation tasks, and more. Neural networks may be used to process input signals (or a transformation of the input signals) through multiple layers, in which each layer may apply a function on its input to produce an input for the next layer. In a transformer-based neural network, this function may include transforming the input into a plurality of tokens, which may then be processed using an attention mechanism, such as a multi-head self-attention or a cross-attention mechanism) to generate an updated plurality of tokens.

Transformer-based neural networks may be applied on different signals and data types, such as images, text, audio, etc. For sequential processing, transformer-based neural networks are often applied iteratively on each data instance included in sequential input data, such as video frames, text words and more. However, performing attention processing between two sets of tokens, or between a single set to itself, may incur a computational load which increases quadratically with respect to the token size.

### SUMMARY

Provided are systems, methods, and devices which may enhance efficiency and reduce computational demands when performing neural network processing tasks on sequential input data by pruning input tokens based on previous data instances included in the sequential input data.

Additional aspects will be set forth in part in the description which follows and, in part, will be apparent from the description, or may be learned by practice of the presented embodiments.

In accordance with an aspect of the disclosure, an electronic device for processing sequential input data includes: at least one processor; and memory configured to store a transformer-based neural network model, and instructions which, when executed by the at least one processor, cause the electronic device to: obtain sequential input data comprising a first data instance corresponding to a first time point, and a second data instance corresponding to a second time point subsequent to the first time point; provide a plurality of first input tokens corresponding to the first data instance to at least one attention block included in the transformer-based neural network model to obtain a plurality of first output tokens; generate a plurality of first output importance scores corresponding to the plurality of first output tokens; generate a plurality of first input importance scores corresponding to the plurality of first input tokens based on the plurality of first output importance scores; propagate the plurality of first input importance scores from the first data instance to the second data instance to generate a plurality of second input importance scores corresponding to the second data instance; prune a plurality of second input tokens corresponding to the second data instance based on the plurality of second input importance scores to obtain a pruned plurality of second input tokens; and provide the pruned plurality of second input tokens to the at least one attention block to obtain a plurality of second output tokens.

In accordance with an aspect of the disclosure, a method for processing sequential input data includes: obtaining sequential input data comprising a first data instance corresponding to a first time point, and a second data instance corresponding to a second time point subsequent to the first time point; providing a plurality of first input tokens corresponding to the first data instance to at least one attention block included in a transformer-based neural network model to obtain a plurality of first output tokens; generating a plurality of first output importance scores corresponding to the plurality of first output tokens; generating a plurality of first input importance scores corresponding to the plurality of first input tokens based on the plurality of first output importance scores; propagating the plurality of first input importance scores from the first data instance to the second data instance to generate a plurality of second input importance scores corresponding to the second data instance; pruning a plurality of second input tokens corresponding to the second data instance based on the plurality of second input importance scores to obtain a pruned plurality of second input tokens; providing the pruned plurality of second input tokens to the at least one attention block to obtain a plurality of second output tokens.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram of a system for performing artificial intelligence (AI) processing, according to embodiments;

FIG. 2 is a block diagram showing a transformer-based neural network applied on sequential data, according to embodiments;

FIG. 3 is a block diagram of an attention block, according to embodiments;

FIG. 4 is a block diagram showing a transformer-based neural network including skip connections, according to embodiments;

FIG. 5A-5B illustrate examples of token pruning schemes, according to embodiments;

FIG. 6 is a block diagram showing an example of token pruning, according to embodiments;

FIG. 7 is a block diagram showing an example of token pruning performed at intermediate layers, according to embodiments;

FIG. 8 is a diagram showing an example of output token score generation for an object detection task, according to embodiments;

FIG. 9 is a block diagram showing temporal propagation of attention rollout for attention blocks with unequal number of input and output tokens; and

FIG. 10 is a flowchart of an example process for performing neural network processing on sequential data, according to embodiments.

### DETAILED DESCRIPTION

As discussed above, transformer-based neural networks may be applied to different signals and data types, for example images, text, and audio, in order to perform various tasks. Many of these tasks may be performed based on sequential input data, which may include a plurality of data instances which are arranged in a particular sequence. According to embodiments, a neural network may include a plurality of attention blocks, which may also be referred to as layers, in which a set of input data tokens (e.g., a set of input vectors) may attend one another. For example, according to embodiments, each attention block may process its set of input tokens by calculating attentions (e.g., attention scores) between the input tokens (and/or other tokens). These attentions may be calculated using a function of different elements, such as a dot product of two vectors. The set of resulting attentions generated by a single attention block may be viewed as an attention map having a size of N×N, where N may denote the number of tokens.

However, processing the attentions between two sets of tokens, or between a single set and itself, may incur a computational load which increases quadratically with respect to the token size. Therefore, it may be beneficial to reduce a computational load of transformer-based networks by pruning a subset of the processed tokens. Accordingly, embodiments may provide methods, systems, and devices for performing token pruning in an attention-based neural network applied on sequential input data.

According to embodiments, the influence of particular input tokens on the output generated by the neural network (e.g., the network output) may be considered using attention rollout, which may refer to a multiplication of attention maps involved in producing the output the neural network. The influence of previous data instances on their corresponding network output, which may be determined based on the attention rollout, may be used to determine an importance score for each input token. These scores may then be propagated from a set of input tokens corresponding to a previous data instance (e.g., a first data instance) to a set of current input tokens corresponding to a current data instance (e.g., a second data instance subsequent to the first data instance). Pruning may then applied based on the propagated scores to obtain a pruned set of current input tokens which may be used as the input to the attention block, instead of the entire set of current input tokens, in order to reduce a computational load of the transformer-based neural network.

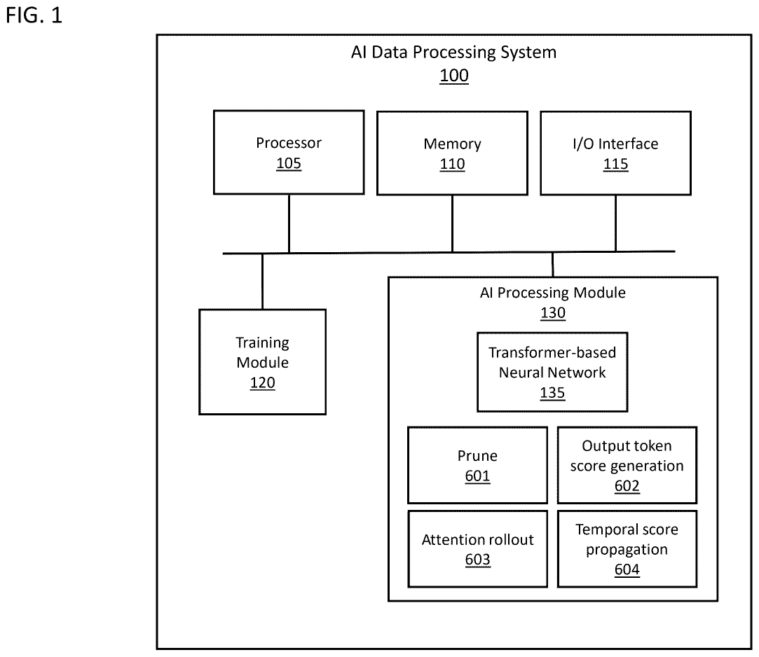

FIG. 1 is a block diagram of a system for performing artificial intelligence (AI) data processing, according to embodiments. As shown in FIG. 1, the AI data processing system 100 may include a processor 105, a memory 110, an input/output (I/O) interface 115, an AI processing module 130, and a training module 120.

The processor 105 may be, or may include, an intelligent hardware device, (e.g., a general-purpose processing component, a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In embodiments, the processor 105 may configured to operate a memory array using a memory controller. For example, a memory controller may be integrated into the processor 105. In embodiments, the processor 105 may be configured to execute computer-readable instructions stored in a memory to perform various functions. However, embodiments are not limited thereto, and the memory controller may be included in any other element of the AI data processing system 100, for example in the memory 110.

The memory 110 (e.g., a memory device) may include at least one of a random access memory (RAM), a read-only memory (ROM), and a hard disk. For example, the memory 110 may include solid state memory and a hard disk drive. The memory 110 may be used to store computer-readable and computer-executable software including instructions which, when executed, may cause the processor 105 to perform various functions described herein. For example, the memory 110 may include, among other things, a basic input/output system (BIOS) which may control basic hardware or software operation such as the interaction with peripheral components or devices. In embodiments, the memory controller may operate memory cells. For example, the memory controller may include a row decoder, column decoder, or both. In some cases, memory cells within a memory 110 store information in as a logical state of the memory cells.

The I/O interface 115 may manage signals which are input from and output to the AI data processing system 100 and the elements included therein. The I/O interface 115 may also manage peripherals which not integrated into a device. For example, the I/O interface 115 may represent a physical connection or port to an external peripheral. In embodiments, the I/O interface 115 may utilize an operating system such as iOS®, ANDROID®, MS-DOS®, MS-WINDOWS®, OS/2®, UNIX®, LINUX®, or another operating system. In embodiments, the I/O interface 115 may represent or interact with a modem, a keyboard, a mouse, a display, a touchscreen, or a similar device. In embodiments, the I/O interface 115 may be implemented as part of a processor 105. In embodiments, a user may interact with a device using the I/O interface 115 or using hardware components controlled by the I/O interface 115.

The training module 120 may be configured to train AI, machine learning (ML), and/or neural network models or architectures included in the AI data processing system 100, for example at least one of an ML model and an AI model included in the AI processing module 130. In embodiments, the AI data processing system 100 may implement one or more AI, ML, and neural network models to perform specialized tasks. For example, at least one of an AI, ML, and neural network processing may be implemented for to perform a task such as a classification task, an object localization task, an object detection task, an image segmentation task, an object recognition task, a named-entity recognition task, a language modeling task, a natural language processing task, and a question answering task. Accordingly the training module 120 may be configured to train a model to perform the at least one of the AI, ML, and neural network processing.

According to embodiments, a neural network may refer to a type of computer algorithm that is capable of learning specific patterns without being explicitly programmed, but through iterations over known data. A neural network may refer to a cognitive model that includes input nodes, hidden nodes, and output nodes. Nodes in the neural network may have an activation function that computes whether the node is activated based on the output of previous nodes. Training the neural network may involve supplying values for the inputs, and modifying edge weights and activation functions (algorithmically or randomly) until the result closely approximates a set of desired outputs.

An artificial neural network (ANN) may refer to a hardware or a software component that includes a number of connected nodes (e.g., artificial neurons), which may loosely correspond to the neurons in a human brain. Each connection, or edge, may transmit a signal from one node to another (similar to the physical synapses in a brain). When a node receives a signal, the node may process the signal and then transmit the processed signal to other connected nodes. In embodiments, the signals between nodes may include real numbers, and the output of each node may be computed by a function of the sum of its inputs. In embodiments, the nodes may determine their outputs using other mathematical algorithms (e.g., selecting the max from the inputs as the output) or any other suitable algorithm for activating the node. Each node and edge may be associated with one or more node weights which may be used to determine how the signal is processed and transmitted.

During a training process, these weights may be adjusted, for example by the training module 120, to improve the accuracy of the result (e.g., by minimizing a loss function which corresponds in some way to the difference between the current result and the target result). The weight of an edge increases or decreases the strength of the signal transmitted between nodes. In embodiments, nodes may have a threshold below which a signal is not transmitted at all. In some embodiments, the nodes may be aggregated into layers, and different layers may perform different transformations on their inputs. The initial layer may be referred to as the input layer, and the last layer may be referred to as the output layer. In some embodiments, signals may traverse certain layers multiple times. In embodiments, at least one of the weights and thresholds may be referred to as model parameters.

In embodiments, the training module 120 may be used to train at least one of an AI, ML, and neural network model included in the AI data processing system 100, for example a model included in the AI processing module 130.

The AI processing module 130 may be used to perform AI processing on input data, which may include sequential input data such as, for example, a sequence of image frames such as a video, a sequence of text words, or audio signal. For example, the AI processing module 130 may include transformer-based neural network model 135 (illustrated as “Transformer-based Neural Network”) that may be configured to perform a neural network task based on sequential input data. For example, the neural network task may include at least one from among an image processing task, a text processing task, and an audio processing task, but embodiments are not limited thereto. In particular, the neural network task may include at least one from among a classification task, an object localization task, an object detection task, an image segmentation task, an object recognition task, a named-entity recognition task, a language modeling task, a natural language processing task, and a question answering task, but embodiments are not limited thereto. The AI processing module 130 may perform the neural network processing task by applying the transformer-based neural network model 135 iteratively to each data instance included in the sequential input data. For example, the sequential input data may include a first data instance corresponding to a first time point, and a second data instance corresponding to a second time point subsequent to the first time point, and so on. Accordingly, the AI processing module 130 may apply the transformer-based neural network model 135 to the first data instance to obtain a first output, and subsequently may apply the transformer-based neural network model 135 to the second data instance to obtain a second output.

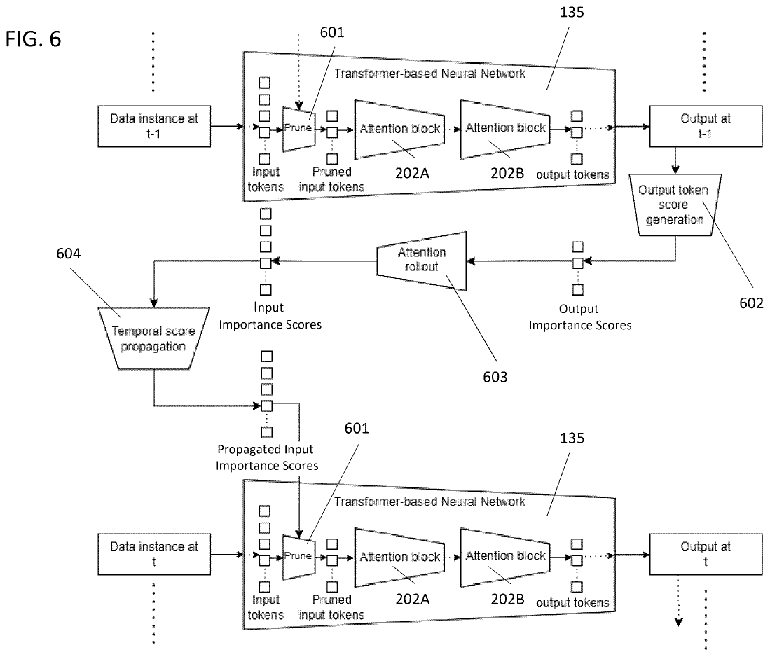

As shown in FIG. 1, the AI processing module may also include a pruning module 601 (illustrated as “Prune”), an output token score generation module 602, an attention rollout module 603, and a temporal score propagation module 604. According to embodiments, the output token score generation module 602 may be used to generate output importance scores corresponding to output tokens generated based on a particular data instance, and the attention rollout module 603 and the temporal score propagation module 604 may use those output importance scores to generate input importance scores corresponding to a subsequent data instance. These input importance scores may be used by the pruning module 601 to perform pruning on input tokens corresponding to the subsequent data instance in order to reduce the computational load of the transformer-based neural network model 135. Example operations of the pruning module 601, the output token score generation module 602, the attention rollout module 603, and the temporal score propagation module 604 are described below with reference to FIGS. 6-9.

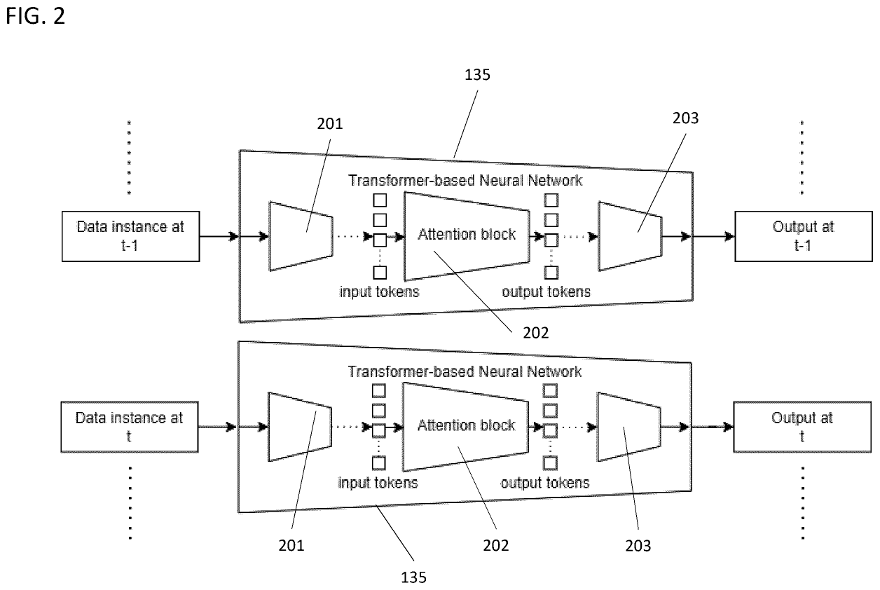

FIG. 2 is a block diagram showing a transformer-based neural network applied on sequential input data, according to embodiments. According to embodiments, the sequential input data may include, for example, a video, a sequence of text words in text, or an audio sequence. The transformer-based neural network model 135 may be applied iteratively on each data instance included in the sequential input data, for example each video frame included in the video, each word included in the sequence of words, and each audio instance included in the audio sequence. The same or similar transformer-based neural network model 135 may be applied on each data instance in the sequence.

For example, as shown in FIG. 2, the transformer-based neural network model 135 may be applied to a data instance corresponding to a time point t−1, which may be referred to as a previous data instance and a first data instance, to generate an output corresponding to the time point t−1. In embodiments, this may mean that the data instance corresponding to the time point t−1 is provided as input to the transformer-based neural network model 135, which may perform neural network operations to generate the output corresponding to the time point t−1. Subsequently, the same or similar transformer-based neural network model 135 may be applied to a data instance at a time point t, which may be referred to as a current data instance, and a second data instance subsequent to the first data instance, to generate an output corresponding to the time point t.

As shown in FIG. 2, the transformer-based neural network model 135 may include one or more input blocks 201, one or more attention blocks 202, and one or more output blocks 203. According to embodiments, each of the one or more attention blocks 202 may be referred to as a layer of the transformer-based neural network model 135. In embodiments, a data instance may be input to the transformer-based neural network model 135, and the one or more input blocks 201 may process the data instance to generate a plurality of tokens (e.g., a plurality of data vectors) which may represent or otherwise correspond to the data instance. The plurality of tokens may be provided as input (e.g., a plurality of input tokens) to the one or more attention blocks 202, which may process the plurality of tokens to generate an updated plurality of tokens (e.g., a plurality of output tokens). According to embodiments, the one or more attention blocks 202 may be arranged in a series, and each attention block 202 may receive and process a plurality of input tokens to generate a plurality of output tokens, which may be provided as input tokens to the next attention block in the series. In embodiments, the one or more output blocks 203 may receive a plurality of output tokens from the one or more attention blocks 202 (e.g., a final plurality of output tokens generated by the final attention block 202 in the series), and may process the plurality of output tokens to generate the output of the transformer-based neural network model 135 for the data instance.

According to embodiments, the attention blocks 202 may be referred to as attention-based processing blocks. Each attention block 202 may process input data that is grouped into a plurality of input tokens, where each input token may attend other tokens (e.g., other tokens included in the plurality of input tokens and/or other tokens included in an external set of tokens), using a set of operations such as dot product. According to embodiments, the one or more attention blocks 202 may have different types. For example, the one or more attention blocks may include at least one from among a multi-head self-attention block, in which the plurality of input tokens attend themselves in parallel network branches, and a multi-head cross attention block, in which the plurality of input tokens attend an external set of tokens. According to embodiments, each attention block 202 included in the transformer-based neural network model 135 may have a similar structure, but may have different weights or parameters obtained through training performed using the training module 120. However, embodiments are not limited thereto, and in some embodiments the attention blocks 202 may have different structures, and/or may have the same weights.

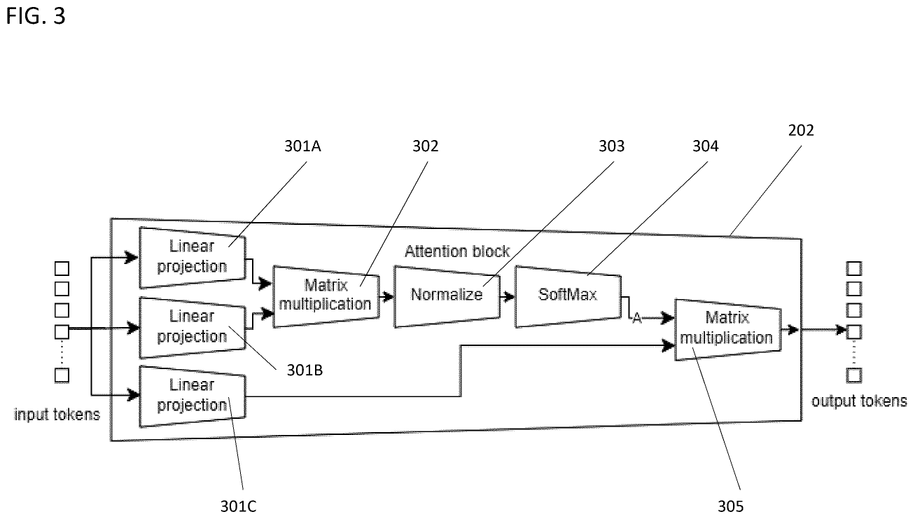

FIG. 3 is a block diagram of an attention block, according to embodiments. As shown in FIG. 3, the attention block 202 may include one or more linear projection blocks 301 (e.g., a linear projection block 301A, a linear projection block 301B, and a linear projection block 301C), a matrix multiplication block 302, a normalization block 303, a SoftMax block 304, and an output matrix multiplication block 305. The attention block 202 may receive a plurality of input tokens, which may be or may include a plurality of tokens generated by the one or more input blocks 201 and/or another attention block 202. The attention block 202 may process the plurality of input tokens (e.g., by performing neural network processing operations) to generate a plurality of output tokens, which may be provided as input to another attention block 202 and/or the one or more output blocks 203. Accordingly, the transformer-based neural network model 135 may use the attention block 202 while performing a neural network task.

In the example shown in FIG. 3, the linear projection blocks 301 may be used to calculate a query Q, a key K, and a value V for each input token. For example, the linear projection block 301A may be used to calculate the query Q, the linear projection block 301B may be used to calculate the key K, and the linear projection block 301C may be used to calculate the value V. For example, the matrix multiplication block 302 may multiply the query Q for each input token by the keys K for all of the other input tokens, and then the normalization block 303 and the SoftMax block 304 may be applied to obtain an attention matrix A, which may include weights for each input token with respect to all of the other input tokens. Then, the output matrix multiplication block 305 may multiply the attention matrix A by the values V to obtain the output tokens of the attention block 202.

In some embodiments, the attention block 202 may repeat the computations multiple times in parallel, which may be referred to as multi-head self-attention. Each of these parallel computation processes may be referred to as an attention head. For example, the attention block 202 may split its query Q, key K, and value V parameters and pass each split independently through a separate attention head. All of these similar Attention calculations are then combined together to produce a final Attention score, and then concatenate the results to produce the output tokens of the attention block 202.

Although examples are described above which relate to self-attention, in which the set of input tokens attends itself (e.g., the same set of input tokens is applied to all of the linear projection blocks 301), embodiments are not limited thereto. For example, in some embodiments, the attention block 202 may apply cross-attention, in which the set of input tokens attends a different set of tokens (e.g., an external set of tokens). In addition, in some embodiments, the tokens used in cross-attention may be divided into multiple token sets where each is processed separately and then concatenated, which may be referred to as multi-head cross-attention.

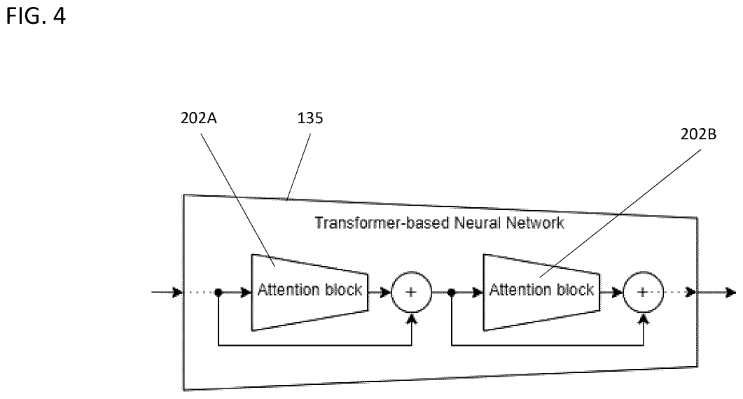

FIG. 4 is a block diagram showing a transformer-based neural network including skip connections, according to embodiments. According to embodiments, skip connections may allow information to bypass one or more blocks or layers, creating shortcuts within the transformer-based neural network model 135. This bypassing may be achieved by adding the output of an earlier layer to the output of a later layer.

For example, as shown in FIG. 4, the transformer-based neural network model 135 may include an attention block 202A, and an attention block 202B subsequent to the attention block 202A. A skip connection may be formed between a previous block and the attention block 202B, and another skip connection may be formed between the attention block 202A and a subsequent block. In the example illustrated in FIG. 4, at least a portion of the input to the attention block 202A (e.g., at least a portion of the output of the previous block before the attention block 202A) may be provided as an input to the attention block 202B, without being processed by the attention block 202A. In addition, at least a portion of the input to the attention block 202B (e.g., at least a portion of the output of the attention block 202A) may be provided as an input to the subsequent block after the attention block 202B, without being processed by the attention block 202B. However, this is only an example, and embodiments are not limited thereto.

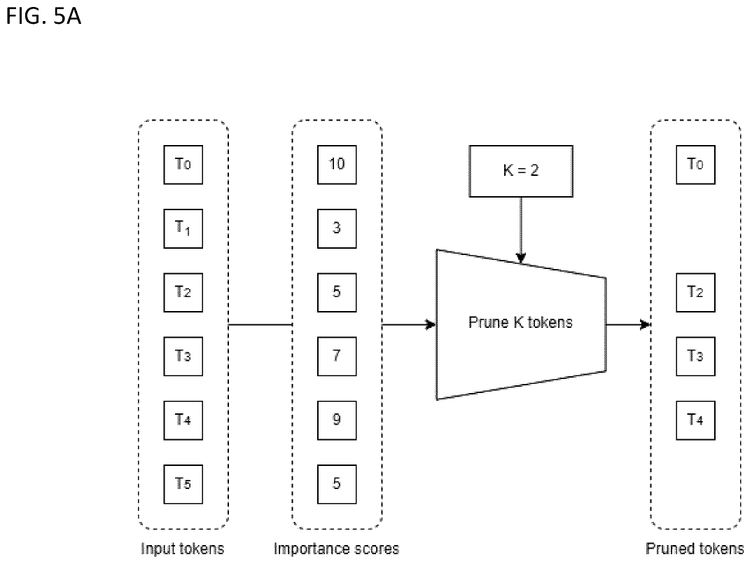

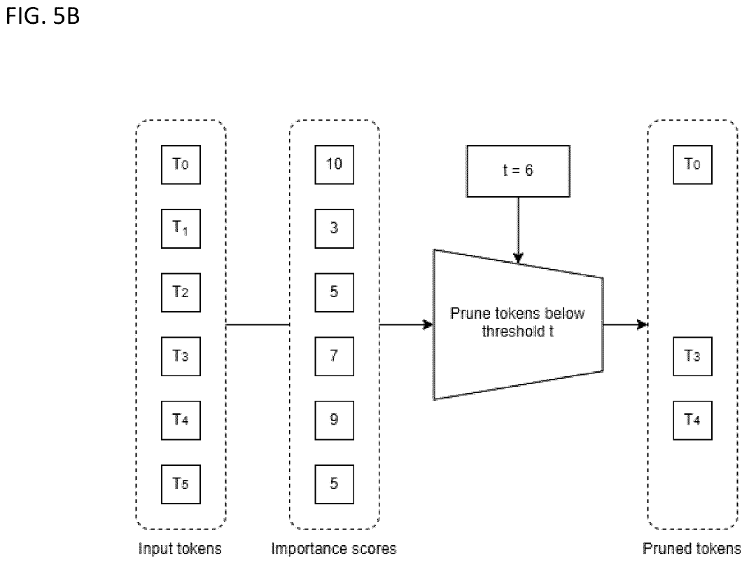

FIG. 5A-5B illustrate examples of token pruning schemes, according to embodiments. As discussed above, calculating the attentions (e.g., attention scores) between two sets of tokens, or between a single set to itself, may incur a computational load which increases quadratically with respect to the number of tokens. Accordingly, embodiments may perform token pruning in order to reduce the number of tokens, and in turn reduce the computational load of one or more attention blocks, in which may result in a more efficient processing. Reducing an amount of computations may improve power consumption, runtime and other design consideration in different platforms. According to embodiments, tokens may be pruned based on their importance.

For example, each token included in a plurality of tokens may be assigned an importance score, and the importance scores may be used to select tokens to be pruned (e.g., removed) from the plurality of tokens. In the examples shown in FIGS. 5A-5B, the plurality of tokens may be a plurality of input tokens including a token T₀ corresponding to an importance score of ten (“10”), a token T₁ corresponding to an importance score of three (“3”), a token T₂ corresponding to an importance score of five (“5”), a token T₃ corresponding to an importance score of seven (“7”), a token T₄ corresponding to an importance score of nine (“9”), and a token T₅ corresponding to an importance score of five (“5”). Examples of determining the importance scores for tokens are described below with reference to FIGS. 6-8. According to embodiments, these importance scores may be used to guide the pruning process. For example, tokens corresponding to relatively low importance scores may be pruned using various pruning schemes.

FIG. 5A illustrates an example of a token pruning scheme in which a predetermined number K of tokens are pruned. In the example shown in FIG. 5A, K=2, which may mean that tokens corresponding to the two lowest importance scores may be pruned to obtain the pruned plurality of tokens. Therefore, because the importance score of three (“3”) and the importance score of five (“5”) are the lowest importance scores, the token T₁ and the token T₅ may be pruned. As can be seen in FIG. 5A, even though the token T₂ may also have an importance score of five (“5”), this token may not be pruned, because only two tokens are to be pruned. When two different tokens correspond to the same importance score, the token to be pruned may be chosen according to another consideration, or may be chosen arbitrarily.

FIG. 5B illustrates an example of a token pruning scheme in which every token corresponding to an importance score less than a predetermined threshold score t is pruned. In the example shown in FIG. 5B, t=6, which may mean that tokens corresponding to importance scores which are less than six (“6”) may be pruned to obtain the pruned plurality of tokens. Therefore, because the importance score of three (“3”) and the importance score of five (“5”) are less than the threshold score, the token T₁, the token T₂, the token T₅ may be pruned.

Although particular examples of pruning schemes are described above, embodiments are not limited thereto, and other importance-guided pruning schemes may also be applied.

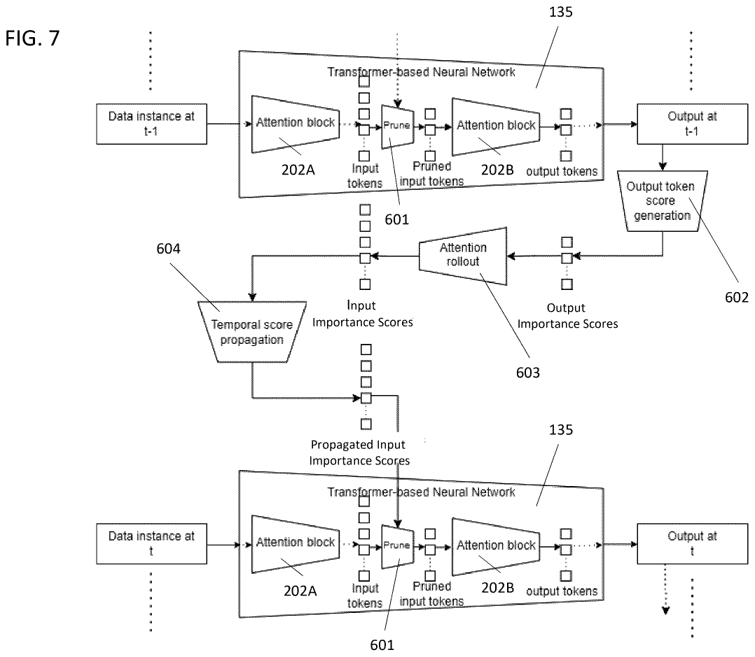

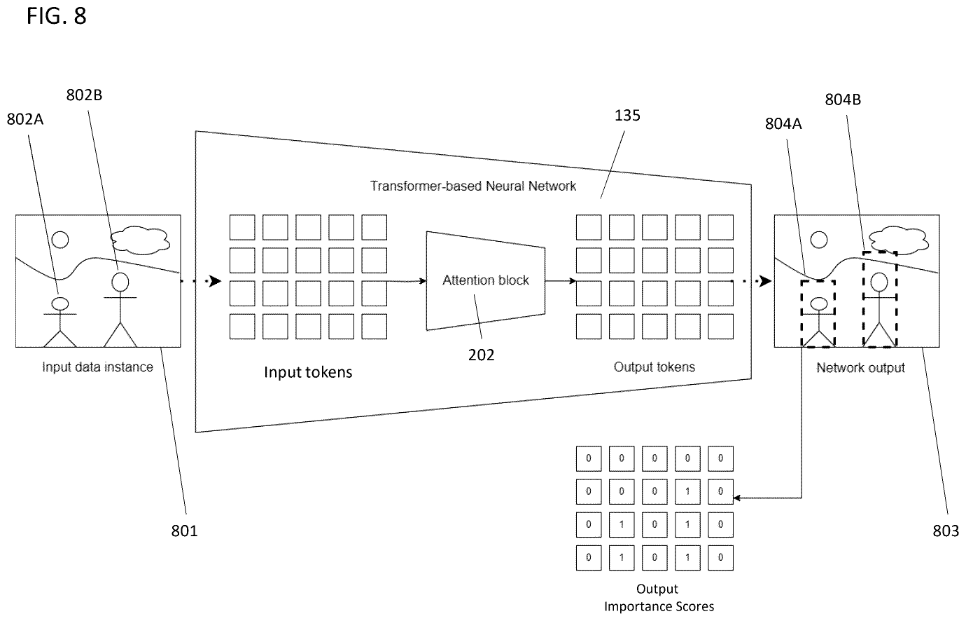

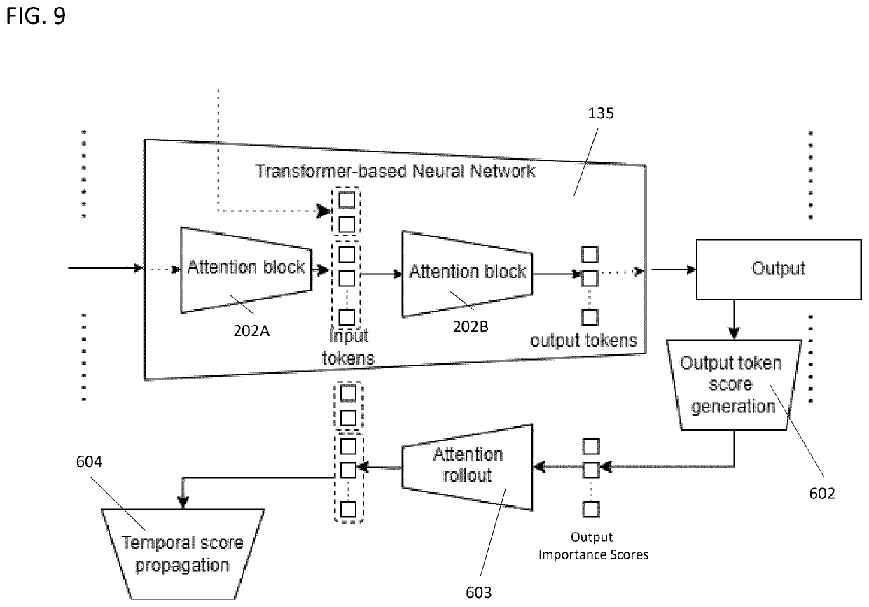

FIGS. 6-7 are block diagrams showing examples of token pruning, according to embodiments. As shown in FIGS. 6-7, the pruning module 601, the output token score generation module 602, the attention rollout module 603, and the temporal score propagation module 604 included in the AI processing module 130 may be used to generate importance scores and prune input tokens used by the transformer-based neural network model 135 to process sequential input data. For convenience of depiction, the one or more input blocks 201 and the one or more output blocks 203 are omitted from the transformer-based neural network model 135 illustrated in FIGS. 6-7 (as well as FIGS. 8-9), and the pruning module 601 is illustrated as being included in the transformer-based neural network model 135. However, according to embodiments, the transformer-based neural network model 135 may include the one or more input blocks 201 and the one or more output blocks 203 as discussed above. In addition, one or more of the pruning module 601, the output token score generation module 602, the attention rollout module 603, and the temporal score propagation module 604 may be included in the transformer-based neural network model 135, or may be separate from the transformer-based neural network model 135.

As shown in FIG. 6-7, an output of the transformer-based neural network model 135 based on a first data instance (e.g., the data instance corresponding to the time point t−1) may be used to generate a plurality of input importance scores corresponding to a plurality of second input tokens for a second data instance subsequent to the first data instance (e.g., the data instance corresponding to the time point t). The plurality of importance scores may then be used by the pruning module 601 included in the AI processing module 130 to prune the plurality of second input tokens, and the pruned plurality of second input tokens may be provided as input to the attention block 202 to allow the transformer-based neural network model 135 to generate output corresponding to the second data instance.

FIGS. 6-7 illustrate examples in which the transformer-based neural network model 135 includes an attention block 202A and also an attention block 202B after the attention block 202A. Accordingly, because the attention block 202B may receive input tokens from another attention block 202 (e.g., the attention block 202A), the attention block 202B may be referred to as an intermediate layer or intermediate block. In the example shown in FIG. 6, the pruning is performed on a plurality of input tokens corresponding to the attention block 202A. However, embodiments are not limited thereto. For example, in some embodiments, the pruning may be performed on a plurality of input tokens corresponding to an intermediate block such as the attention block 202B, as shown for example in FIG. 7. In addition, in some embodiments, the pruning may be performed on multiple pluralities of input tokens, for example the plurality of input tokens corresponding to the attention block 202A and also plurality of input tokens corresponding to the attention block 202B.

According to embodiments, the output token score generation module 602 may be used to generate a plurality of first output importance scores which indicate an importance of each first output token included in the plurality of first output tokens generated by the transformer-based neural network model 135 based on the first data instance. As discussed above, the transformer-based neural network model 135 according to embodiments may be used to generate a plurality of output tokens for each data instance, and the plurality of output tokens may be used to generate an output corresponding to a neural network task. For example, based on the neural network task being a classification task in which an object included in an input image is to be classified, the plurality of output tokens may be used to generate an output including a classification result (e.g., class scores or a specific class from a set of classes) corresponding to the object. As another example, based on the neural network task being an object localization task in which a location of an object within an input image is to be determined, the plurality of output tokens may be used to generate an output including a bounding box indicating the location of the object.

According to embodiments, the plurality of output importance scores generated by the output token score generation module 602 may indicate the importance of the plurality of output tokens with respect to, or in consideration of, the neural network task. For example, for a classification task, the plurality of output tokens may include a class token which may be used as a global representation of a frame or video, and may be directly used for classification in later computations. Therefore, the class token may be assigned an output importance score of one (“1”), and all of the other output tokens included in the plurality of output tokens may be assigned an output importance score of zero (“0”). For localization and detection tasks, output tokens associated with detected bounding boxes may be assigned an output importance score of one (“1”), and all other tokens may be assigned an output importance score of zero (“0”). For other tasks or transformer architectures, output importance scores may be set to one (“1”) for all tokens (uniform importance), or may be set or assigned in any other manner. In embodiments, the plurality of output importance scores may be included in a vector, which may be referred to for example as an output importance score vector.

FIG. 8 is a diagram showing an example of output token score generation for an object detection and localization task, according to embodiments. As shown in FIG. 8, the transformer-based neural network model 135 may receive as input an image 801 including an object 802A and an object 802B. The transformer-based neural network model 135 may generate a plurality of input tokens corresponding to the input image 801 (for example, using the one or more input blocks 201), and the plurality of input tokens may be provided to the one or more attention blocks in order to generate a corresponding plurality of output tokens. The plurality of output tokens may be then be used (e.g., by the one or more output blocks 203) to generate a list of bounding boxes. For example, the bounding boxes may be, or may include, metadata that may be produced by the transformer-based neural network model 135 to describe the input image 801. For example, as shown in FIG. 8, an output image 803 may include a bounding box 804A corresponding to the object 802A, and a bounding box 804B corresponding to the object 802B, and the bounding boxes 804A and 804B may be generated based on the plurality of output tokens.

As shown in FIG. 8, the output token score generation module 602 may generate a plurality of output importance scores (which may be included in, or referred to as, an output importance score map) which may indicate an importance of each of the plurality of output tokens. As discussed above, the output token score generation module 602 may generate those output importance scores based on the output image 803, in consideration of the object detection and localization task. For example, the output token score generation module 602 may set output importance scores corresponding to output tokens associated with the bounding boxes 804A and 804B to a value of one (“1”), and may set all other output tokens included in the plurality of output tokens to a value of zero (“0”), as shown in FIG. 8.

Referring again to FIGS. 6-7, after being generated by the output token score generation module 602, the plurality of first output importance scores may be provided to the attention rollout module 603. The attention rollout module 603 may be used to generate an attention rollout matrix that may indicate the relationship between each first input token from among the plurality of first input tokens and each first output token from among the plurality of first output tokens.

According to embodiments, the attention rollout matrix may be calculated by iteratively multiplying the attention maps generated by the transformer-based neural network model 135. For example, for a token set generated by the transformer-based neural network model 135 while processing the first data instance, a corresponding attention rollout matrix Aᵣₒₗₗₒᵤₜⁱ may be calculated according to Equation 1 below:

$${A}_{rollout}^{i} = {A}_{L} \cdot {A}_{L - 1} \cdot … \cdot {A}_{i} \qquad ( Equation 1 )$$

In Equation 1 above, {Aₗ}ₗ₌ᵢ^{L} may denote the attention maps generated by the transformer-based neural network model 135, and i may denote the index of a token set (or a corresponding layer in the transformer-based neural network model 135). According to embodiments, when a skip connection is used in the transformer-based neural network model 135, the attention rollout matrix Aᵣₒₗₗₒᵤₜⁱ may be calculated according to Equation 2 below:

$${A}_{rollout}^{i} = ( {A}_{L} + I ) \cdot ( {A}_{L - 1} + I ) \cdot … \cdot ( {A}_{i} + I ) \qquad ( Equation 2 )$$

In Equation 2 above, I may denote the identity matrix. Each token set produced by the transformer-based neural network model 135 while processing the first data instance may be associated with an attention rollout matrix Aᵣₒₗₗₒᵤₜⁱ.

According to embodiments, the attention rollout matrix may be used to determine importance score of each first input token included in the plurality of first input tokens by multiplication with the plurality of first output importance scores according to Equation 3 below:

$${I}_{in}^{i} = {A}_{rollout}^{i} \cdot {I}_{out} \qquad ( Equation 3 )$$

In Equation 3 above, Iᵢₙⁱ may denote the input importance scores of the i-th input token set and Iₒᵤₜ may denote the output importance scores of the plurality of first output tokens. According to embodiments, in the example shown in FIG. 6, the plurality of first input importance scores may correspond to a plurality of first input tokens provided as input to the attention block 202A, and therefore the attention rollout matrix may be calculated according to an index corresponding to the attention block 202A. In addition, in the example shown in FIG. 7, the plurality of first input importance scores may correspond to a plurality of first input tokens provided as input to the attention block 202B, and therefore the attention rollout matrix may be calculated according to an index corresponding to the attention block 202B.

After the plurality of first input importance scores are calculated, the temporal score propagation module 604 may propagate the plurality of first input importance scores from the first data instance (e.g., the data instance corresponding to the time t−1) to the second data instance (e.g., the data instance corresponding to the time t) so that the propagated input importance scores may be used to perform pruning on a plurality of second input tokens corresponding to the second data instance. According to embodiments, the propagated input importance scores may indicate an importance of each second input token included in the plurality of second input tokens (determined based on the importance of the plurality of first input tokens).

According to embodiments, the temporal score propagation module 604 may propagate importance scores of tokens generated at index i while processing the first data instance to generate importance scores of the corresponding tokens generated while processing the second data instance. The goal of the transformation may be to account for temporal changes between the first data instance and the second data instance, and the transformation be may be performed using various techniques. For example, each first input token from among the plurality of first input tokens may be associated a with a most similar second input token from among the plurality of second input tokens, and the resulting mapping may be used to transform the plurality of first input importance scores to obtain the plurality of second input importance scores. According to embodiments, the similarity may be determined according to any metric, for example norm distance.

According to embodiments, the temporal score propagation module 604 may also consider other factors when generating the plurality of second input importance scores. For example, in addition to the plurality of first input importance scores, the temporal score propagation module 604 may also set the plurality of second input importance scores based on a magnitude of the tokens, or any other metric.

After the plurality of second input important scores are determined, the pruning module 601 may use them to prune the plurality of second input tokens, and the transformer-based neural network model 135 may process the second data instance based on the pruned plurality of second input tokens. According to embodiments, pruning may be performed for a single layer or block included in the transformer-based neural network model 135, or for multiple layers or blocks included in the transformer-based neural network model 135. For example, in some embodiments, the transformer-based neural network model 135 may include a plurality of pruning modules 601 corresponding to a plurality of attention blocks 202. According to embodiments, pruning may be used to prune (e.g., remove) tokens corresponding to relatively low importance scores according to various pruning schemes, examples of which are described above with reference to FIGS. 5A-5B. In some embodiments, the information included in pruned tokens may be transferred or added to remaining tokens. This may be referred to as token merging, in which importance scores may be used equivalently.

As shown in FIGS. 6-7, the pruning module 601 may also perform pruning on the plurality of input tokens corresponding to the first data instance (e.g. the data instance corresponding to the time point t−1). According to embodiments, this pruning may be performed based on importance scores which are generated based on a plurality of previous output importance scores associated with a previous data instance. If no previous data instances are available, the pruning may be performed based on other importance scores (e.g., default importance scores or arbitrary importance scores), or the pruning may be omitted.

FIG. 9 is a block diagram showing temporal propagation of attention rollout for attention blocks with unequal number of input and output tokens. For example, due to pruning, a number of the plurality of first input tokens may be larger than a number of the plurality of first output tokens. For example, if the number of the plurality of input tokens is N (e.g., five), and K (e.g., two) input tokens are pruned, then the output token score generation module 602 may only be able to generate N−K (e.g., three) output importance scores, and therefore the AI processing module 130 may only be able to generate N−K (e.g., three) input importance scores. According to embodiments, In order to calculate input importance scores for the K (e.g., two) tokens that were removed by pruning, the AI processing module 130 may perform interpolation on the N−K (e.g., three) input importance scores generated by the AI processing module 130. For example, the interpolation may be performed based on a similarity value calculated between the N−K (e.g., three tokens) and the K (e.g., two) tokens that were removed by pruning.

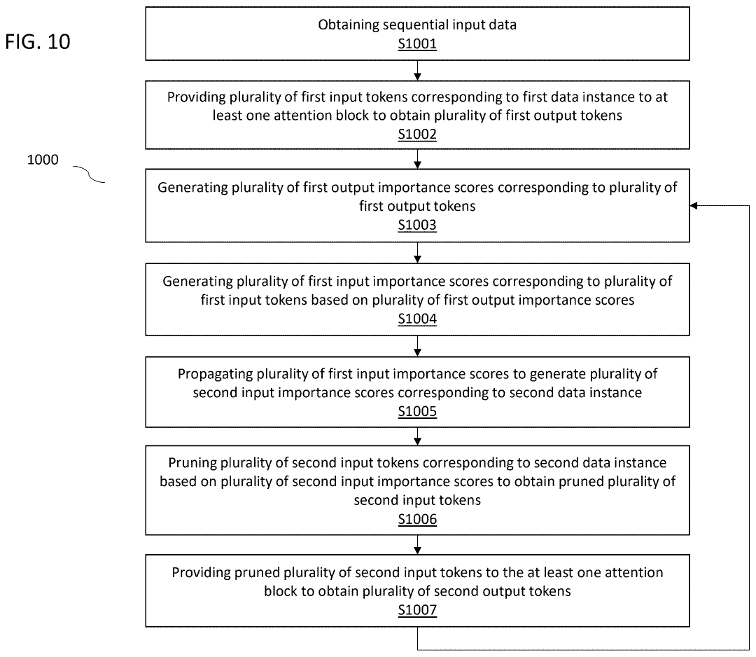

FIG. 10 is a flowchart of an example process for performing neural network processing on sequential data, according to embodiments. In some implementations, one or more process blocks of FIG. 10 may be performed by any of the elements discussed above, for example one or more of the AI data processing system 100, the AI processing module 130, the transformer-based neural network model 135, and any of the components included therein.

As shown in FIG. 10, at operation S1001 the process 1000 may include obtaining sequential input data comprising a first data instance corresponding to a first time point, and a second data instance corresponding to a second time point subsequent to the first time point. According to embodiments, the first time point may correspond to the time point t−1 discussed above, and the second time point may correspond to the time point t discussed above.

As further shown in FIG. 10, at operation S1002 the process 1000 may include providing a plurality of first input tokens corresponding to the first data instance to at least one attention block included in a transformer-based neural network model to obtain a plurality of first output tokens. In embodiments, the at least one attention block may correspond to the attention block 202 discussed above, and the transformer-based neural network model may correspond to the transformer-based neural network model 135 discussed above.

As further shown in FIG. 10, at operation S1003 the process 1000 may include generating a plurality of first output importance scores corresponding to the plurality of first output tokens. In embodiments, operation S1003 may be performed by the output token score generation module 602 discussed above.

As further shown in FIG. 10, at operation S1004 the process 1000 may include generating a plurality of first input importance scores corresponding to the plurality of first input tokens based on the plurality of first output importance scores. In embodiments, operation S1004 may be performed by at least one of the AI processing module 130 and the attention rollout module 603 discussed above.

As further shown in FIG. 10, at operation S1005 the process 1000 may include propagating the plurality of first input importance scores from the first data instance to the second data instance to generate a plurality of second input importance scores corresponding to the second data instance. In embodiments, the plurality of second input importance scores may correspond to the propagated importance scores discussed above with reference to FIGS. 6-7. In embodiments, operation S1005 may be performed by the temporal score propagation module 604 discussed above.

As further shown in FIG. 10, at operation S1006 the process 1000 may include pruning a plurality of second input tokens corresponding to the second data instance based on the plurality of second input importance scores to obtain a pruned plurality of second input tokens. In embodiments, operation S1006 may be performed by the pruning module 601 discussed above.

As further shown in FIG. 10, at operation S1007 the process 1000 may include providing the pruned plurality of second input tokens to the at least one attention block to obtain a plurality of second output tokens.

In embodiments, the pruning may include: selecting a predetermined number of second input tokens corresponding to lowest scores from among the plurality of second input importance scores; and removing the predetermined number of second input tokens from the plurality of second input tokens to obtain the pruned plurality of second input tokens.

In embodiments, the pruning may include: based on determining that at least one importance score from among the plurality of second input importance scores is less than a predetermined threshold score, selecting at least one second input token corresponding to the at least one importance score; and removing the at least one second input token from the plurality of second input tokens to obtain the pruned plurality of second input tokens.

In embodiments, the generating of the plurality of first input importance scores may include: calculating a plurality of attention maps corresponding to a plurality of layers of the transformer-based neural network model; and calculating an attention rollout matrix by iteratively multiplying the plurality of attention maps.

In embodiments, the plurality of first importance scores may be calculated by multiplying the plurality of first output importance scores (e.g., the output importance score vector) by the attention rollout matrix.

In embodiments, the propagating may include: mapping each first input token included in the plurality of first input tokens with a corresponding second input token from among the plurality of second input tokens; and transforming the plurality of first input importance scores based on the mapping to obtain the plurality of second input importance scores.

In embodiments, the at least one attention block may include at least one from among a multi-head self-attention block and a multi-head cross attention block.

In embodiments, the transformer-based neural network model may be trained to perform a neural network processing task, and wherein the plurality of first output importance scores are generated based on a result of the neural network processing task.

In embodiments, the neural network processing task may include at least one from among a classification task, an object localization task, an object detection task, an image segmentation task, an object recognition task, a named-entity recognition task, a language modeling task, a natural language processing task, and a question answering task.

In embodiments, the transformer-based neural network model may include a first attention block different from the at least one attention block, and the plurality of first input tokens may be obtained based on an output of the first attention block.

Although FIG. 10 shows example blocks of the process 1000, in some implementations, the process 1000 may include additional blocks, fewer blocks, different blocks, or differently arranged blocks than those depicted in FIG. 10. Additionally, or alternatively, two or more of the blocks of the process 1000 may be arranged or combined in any order, or performed in parallel.

Accordingly, embodiments may allow transformer-based neural networks to be applied on sequential data more efficiently, requiring fewer computations. This may lead to lower latency, higher throughput, lower power consumption, lower bandwidth, reduced memory footprint, reduced area footprint of hardware designs such as application specific integrated circuit (ASIC), and more. In addition, embodiments may also improve pruning processes and in turn improve accuracy of neural networks.

As is traditional in the field, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

The various operations of methods described above may be performed by any suitable means capable of performing the operations, such as various hardware and/or software component(s), circuits, and/or module(s).

The software may include an ordered listing of executable instructions for implementing logical functions, and can be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

The foregoing is illustrative of certain embodiments and is not to be construed as limiting thereof. Although a few embodiments have been described, those skilled in the art will readily appreciate that many modifications are possible in the embodiments without materially departing from the present scope.

What is claimed is:

1. An electronic device for processing sequential input data, the electronic device comprising:
at least one processor; and
memory configured to store a transformer-based neural network model, and instructions which, when executed by the at least one processor, cause the electronic device to:
obtain sequential input data comprising a first data instance corresponding to a first time point, and a second data instance corresponding to a second time point subsequent to the first time point;
provide a plurality of first input tokens corresponding to the first data instance to at least one attention block included in the transformer-based neural network model to obtain a plurality of first output tokens;
generate a plurality of first output importance scores corresponding to the plurality of first output tokens;
generate a plurality of first input importance scores corresponding to the plurality of first input tokens based on the plurality of first output importance scores;
propagate the plurality of first input importance scores from the first data instance to the second data instance to generate a plurality of second input importance scores corresponding to the second data instance;
prune a plurality of second input tokens corresponding to the second data instance based on the plurality of second input importance scores to obtain a pruned plurality of second input tokens; and
provide the pruned plurality of second input tokens to the at least one attention block to obtain a plurality of second output tokens.

2. The electronic device of claim 1, wherein to prune the plurality of second input tokens, the instructions, when executed by the at least one processor, further cause the electronic device to:
select a predetermined number of second input tokens corresponding to lowest scores from among the plurality of second input importance scores; and
remove the predetermined number of second input tokens from the plurality of second input tokens to obtain the pruned plurality of second input tokens.

3. The electronic device of claim 1, wherein to prune the plurality of second input tokens, the instructions, when executed by the at least one processor, further cause the electronic device to:
based on determining that at least one importance score from among the plurality of second input importance scores is less than a predetermined threshold score, select at least one second input token corresponding to the at least one importance score; and
remove the at least one second input token from the plurality of second input tokens to obtain the pruned plurality of second input tokens.

4. The electronic device of claim 1, wherein to generate the plurality of first input importance scores, the instructions, when executed by the at least one processor, further cause the electronic device to:
calculate a plurality of attention maps corresponding to a plurality of layers of the transformer-based neural network model; and
calculate an attention rollout matrix by iteratively multiplying the plurality of attention maps.

5. The electronic device of claim 4, wherein the plurality of first input importance scores are calculated by multiplying the plurality of first output importance scores by the attention rollout matrix.

6. The electronic device of claim 1, wherein to propagate the plurality of first input importance scores, the instructions, when executed by the at least one processor, further cause the electronic device to:
generate a mapping in which each first input token included in the plurality of first input tokens is mapped with a corresponding second input token from among the plurality of second input tokens; and
transform the plurality of first input importance scores based on the mapping to obtain the plurality of second input importance scores.

7. The electronic device of claim 1, wherein the at least one attention block comprises at least one from among a multi-head self-attention block and a multi-head cross attention block.

8. The electronic device of claim 1, wherein the transformer-based neural network model is trained to perform a neural network processing task, and
wherein the plurality of first output importance scores are generated based on a result of the neural network processing task.

9. The electronic device of claim 8, wherein the neural network processing task comprises at least one from among a classification task, an object localization task, an object detection task, an image segmentation task, an object recognition task, a named-entity recognition task, a language modeling task, a natural language processing task, and a question answering task.

10. The electronic device of claim 1, wherein the transformer-based neural network model comprises a first attention block different from the at least one attention block,
wherein the plurality of first input tokens are obtained based on an output of the first attention block.

11. A method for processing sequential input data, the method comprising:
obtaining sequential input data comprising a first data instance corresponding to a first time point, and a second data instance corresponding to a second time point subsequent to the first time point;
providing a plurality of first input tokens corresponding to the first data instance to at least one attention block included in a transformer-based neural network model to obtain a plurality of first output tokens;
generating a plurality of first output importance scores corresponding to the plurality of first output tokens;
generating a plurality of first input importance scores corresponding to the plurality of first input tokens based on the plurality of first output importance scores;
propagating the plurality of first input importance scores from the first data instance to the second data instance to generate a plurality of second input importance scores corresponding to the second data instance;
pruning a plurality of second input tokens corresponding to the second data instance based on the plurality of second input importance scores to obtain a pruned plurality of second input tokens;
providing the pruned plurality of second input tokens to the at least one attention block to obtain a plurality of second output tokens.

12. The method of claim 11, wherein the pruning comprises:
selecting a predetermined number of second input tokens corresponding to lowest scores from among the plurality of second input importance scores; and
removing the predetermined number of second input tokens from the plurality of second input tokens to obtain the pruned plurality of second input tokens.

13. The method of claim 11, wherein the pruning comprises:
based on determining that at least one importance score from among the plurality of second input importance scores is less than a predetermined threshold score, selecting at least one second input token corresponding to the at least one importance score; and
removing the at least one second input token from the plurality of second input tokens to obtain the pruned plurality of second input tokens.

14. The method of claim 11, wherein the generating of the plurality of first input importance scores comprises:
calculating a plurality of attention maps corresponding to a plurality of layers of the transformer-based neural network model; and
calculating an attention rollout matrix by iteratively multiplying the plurality of attention maps.

15. The method of claim 14, wherein the plurality of first input importance scores are calculated by multiplying an output importance score vector comprising the plurality of first output importance scores by the attention rollout matrix.

16. The method of claim 11, wherein the propagating comprises:
mapping each first input token included in the plurality of first input tokens with a corresponding second input token from among the plurality of second input tokens; and
transforming the plurality of first input importance scores based on the mapping to obtain the plurality of second input importance scores.

17. The method of claim 11, wherein the at least one attention block comprises at least one from among a multi-head self-attention block and a multi-head cross attention block.

18. The method of claim 11, wherein the transformer-based neural network model is trained to perform a neural network processing task, and
wherein the plurality of first output importance scores are generated based on a result of the neural network processing task.

19. The method of claim 18, wherein the neural network processing task comprises at least one from among a classification task, an object localization task, an object detection task, an image segmentation task, an object recognition task, a named-entity recognition task, a language modeling task, a natural language processing task, and a question answering task.

20. The method of claim 11, wherein the transformer-based neural network model comprises a first attention block different from the at least one attention block,
wherein the plurality of first input tokens are obtained based on an output of the first attention block.
